(19) United States
(12) Patent Application Publication
(10) Pub. No.: US 2005/0102220 A1
(43) Pub. Date: May 12, 2005

(54) Method and system for investment trading venue selection

(76) Inventor: Dowell Stackpole, Fort Worth, TX (US)

Correspondence Address: Stephen S. Mosher;Whitaker, Chalk, Swindle & Sawyer, LLP, 3500 City Center Tower II, 301 Commerce Street, Fort Worth, TX, 76102-4186, US

(21) Appl. No.: 10/985,438

(22) Filed: Nov. 10, 2004

Related U.S. Application Data
(60) Provisional application No. 60/519,045, filed on Nov. 11, 2003.

(51) Int. Cl. G06F 17/60

(52) U.S. Cl. 705/37

(57) ABSTRACT

There is disclosed a method and system for scoring and selecting investment security trading venues using a computer-based advanced trade order management (ATOM) system. An ATOM program is launched on a user computer. Trading venue execution data and market condition data are processed post-trade at the trader location to compile or update a trade report for the plurality of the trading venues dealing in a particular security. In a pre-trade analysis conducted by the ATOM system prior to executing a trade order, trading venues are ranked according to their trading performance. The rankings are displayed in order of the highest performing venues, to enable the user/trader to select an optimum trading venue for an investment trade.

### CROSS-REFERENCE TO RELATED APPLICATION

The present U.S. Patent Application claims priority from earlier filed U.S. Provisional Patent Application Ser. No. 60/519,045, filed Nov. 11, 2003 and entitled “Method and System for Intelligent Trade Order Management.”

### BACKGROUND OF THE INVENTION

1. Field of the Invention

The present invention generally relates to managing investment trade orders and, more particularly, to an advanced trade order management system and method that analyzes post-trade results to facilitate trading venue selection and reduce trading costs.

2. Description of the Prior Art

Investment securities trading is rapidly moving in the direction of electronic execution. Technologies such as Electronic Communications Networks (ECNs) and crossing networks have changed markets and fragmented the locations where shares are offered and bids placed. Among these locations are market centers and trading venues. Generally, market centers are the stock exchanges and other market institutions such as the OTC market, ECNs, etc. where instruments are listed for sale or purchase and where trading takes place, often through an auction process or trading facilitated by brokers or dealers having access to the exchange or the market. In contrast, trading venues are generally the location of the persons or entities having access to the exchanges or the markets. Often, these are broker/dealers, crossing networks, agents, etc. However, in some cases, the venue could also be an exchange or a particular market itself. Generally though, trading venues are distinguished by their role as intermediaries between buyers or sellers and the market center. In this role, venues provide services to provide information, facilitate the mechanics of trading, determine the routing for a transaction, and the like.

These locations—these trading venues, are dispersed liquidity pools that are creating an environment where the use of intelligent trading systems is becoming critical. Systems such those offered by such venues as State Street, CSFB and Morgan Stanley, that probe for liquidity and algorithmically attempt to reduce trading friction, are becoming absolutely necessary to obtain optimal trading efficiency. While these trading venues continue to improve, there is no verifiably independent measure of how they perform beyond comparison to daily Volume Weighted Average Price (VWAP). Further, as brokers attempt to bring value to their execution clients, there are more and more of these system appearing. What is needed is a system that will rank the performance of these trading venues with several useful indicators.

Investing in financial markets involves large volumes of trading activity in stock and bond markets, commodity exchanges and the like. Numerous parties on both the buy side and the sell side of the activity participate in these transactions. Buy side entities include managers and advisors of hedge funds, financial institutions, family trading offices, retirement funds, school endowments, mutual funds and registered investment advisors—generally any entity that manages the investment of large pools of funds. Sell side entities include brokers, dealers, institutional and retail investment desks and large traditional broker/dealers such as Merrill Lynch, Morgan Stanley, Goldman Sachs, and the like. Buy side entities can be further categorized as to the size of their assets under management. For example, smaller buy side entities may include those managing less than $500 million.

Large entities on either side of the trading transaction are more likely to have networks of computing systems and software adapted to managing the trading activity, systems that are expensive to install and maintain. However, smaller trading entities typically lack the resources for such elaborate trade order management systems and must resort to processing and analyzing their trading activities by less efficient means. This reduced efficiency negatively impacts the cost of trade and hence the competitiveness of the trading entity. As is well known, the cost of a trade includes the sales commission plus the ‘slippage,’ slippage being the difference between the price at the outset of the trade and the price paid. Slippage is a true measure of how well a given trading venue performs. Thus, if a way can be found to reduce the slippage, the cost of the trade can also be reduced and the trading venue, i.e., the broker or dealer or advisor can be more competitive, more profitable, and provide better service to its clients.

In a conventional trade order management system a trade order is processed in sequence from start to finish, from the request of a trade through order entry, working portions of the order according to selected routing destinations, typically via an order broker on the floor of the exchange who accepts the order, routes the trade, executes the trade and reports the results to the manager making the request. Often these steps may be communicated by telephone or electronically. The trade order management system may accumulate data about the trade for use by persons involved in the transaction. However, the selection of the routing of a trade to a trading venue—i.e., the choice of a destination venue—must still be performed by individuals who interpret the data about trading activity in order to select the most efficient venue for executing the trade order. This can be—and often is—a time-consuming and essentially manual process.

What is needed is a method and system to solve the routing problem described above and to enable investment managers and advisors to select the most efficient, lowest cost venue for a securities trade based on analysis of the performance of trading venues active in the particular security of interest. Further, such a system and method should automate as much of the analysis as possible, reducing the selection to the simplest possible intervention, if any, to reduce price slippage and the costs of the individual trade and the aggregate of the trades necessary to process an order. Moreover, such a method and system should minimize the outlay necessary to install and utilize them.

### SUMMARY OF THE INVENTION

Accordingly, there are disclosed methods and systems for scoring and selecting trading venues using a computer at a user location running a program to provide an Advanced Trade Order Management (ATOM) system. Post-trade analysis results for a specified investment are input to a post-trade interface. Trading venue execution data and market condition data from a market feed are input to the system from the post trade interface, processed, and compiled to form factor tables for storage in an aggregator database. A trade report is compiled from the factor tables in the aggregator database for a plurality of trading venues dealing in the specified investment. In a subsequent pre-trade analysis performed prior to placing a trade order, the trade report is accessed and venue performance is scored and displayed on a user monitor, ranked in order of highest performing venues.

In another aspect the system is operable over a communication network for making trading venue routing recommendations. A server is coupled to a communication network via a network interface. A first memory is coupled to the server, having stored therein an Advanced Trade Order Management (ATOM) system program, wherein the ATOM system program is operable to evaluate trading venue performance and rank the trading venues accordingly.

### BRIEF DESCRIPTION OF THE DRAWINGS

FIG. 1A illustrates a block diagram of a prior art trading model;

FIG. 1B illustrates a block diagram of one embodiment of a trading model of the invention according to the present disclosure;

FIG. 2 illustrates a system block diagram of one embodiment of the present disclosure;

FIG. 3 illustrates a flow diagram, primarily from a system perspective, for a method of the embodiment of the present disclosure illustrated in FIG. 2;

FIG. 4A illustrates a first portion of a flow diagram, primarily from a user's perspective, for a method of one embodiment of the present disclosure;

FIG. 4B illustrates a second portion of the flow diagram of FIG. 4A;

FIG. 5 illustrates a screen display for an opening step of the method of FIGS. 4A and 4B;

FIG. 6 illustrates a screen display for a trade ordering step of the method of FIGS. 4A and 4B;

FIG. 7 illustrates a screen display for selecting a trade action step of the method of FIGS. 4A and 4B;

FIG. 8 illustrates a screen display for a step of entering a trade order of the method of FIGS. 4A and 4B;

FIG. 9 illustrates a screen display for a step of checking a trade order of the method of FIGS. 4A and 4B;

FIG. 10 illustrates a screen display for a pre-trade analysis step of the method of FIGS. 4A and 4B; and

FIG. 11 illustrates a screen display for a step of receiving a result of a pre-trade analysis step of the method of FIGS. 4A and 4B.

### DETAILED DESCRIPTION OF THE INVENTION

Introduction

There is disclosed herein an Advanced Trade Order Management (ATOM) system to be made available as a software product for use with a computer to hedge fund managers and registered investment advisors. The software is particularly well suited for enabling the under serviced strata of hedge fund managers and investment advisors with less than $500 million under management to significantly improve their trading venue routing decisions. The system allows these investors to service their accounts more effectively by normalizing and automating transaction and allocation data. It is attractive to hedge fund and investment managers because it requires no information technology investment beyond a typical office computer and the ATOM system, and perhaps a network interface connection and web browser if the ATOM system is to be used on a network or on a global communication network such as the Internet. Furthermore, the ATOM system software product offers access to all major trading venues and tracks the slippage for each trade. This allows the system to make intelligent trade routing recommendations by performing pre-trade analysis of post-trade reports based on previous trading history. The ATOM core system is trading venue agnostic; that is, the core system itself operates without knowledge of the trading venues that perform the trading, showing no preference toward any venue. However, the front end—the interface of the system—can be custom crafted for each user or trader.

A significant advantage to investors and other trading managers is the performance measurement and trade recommendation feature that is provided by the ATOM system. This is provided through a feedback process, which encodes the detailed trade information from the trading venues and the market centers, using factor algorithms to generate non-stock specific, non-price specific data. The process then aggregates the data and creates correlation matrices or tables for each factor. This enables the system to recommend trading venues by factor cluster or factor set. A factor set, as will be described herein below, is a list of the factors (parameters of the trade that took place) and corresponding “band IDs” (coded parameter range values: integers that represent one of several ranges of values, e.g., 1 to 10, 10 to 100, etc., that a given parameter or factor may have) considered during post-trade analysis while measuring the performance of a trading venue for a particular security. To understand the software used in the system, it is helpful to consider it in three components, trade report, aggregation and scoring.

The first of these, a trade report, doesn't actually store the specifics of each trade but rather ranks the performance of the venue for the factors which explain the security traded. This is accomplished through the use of a procedure which, when given a security, returns a set of factors used to describe a trade in the security and the market environment in which it takes place. A factor, also known as a parameter, is a descriptive term derived from raw data; it is not the raw data itself. For example: the average number of shares traded per day in the security is a factor. The system obtains from a market center feed what the value is for a factor of interest, say, average shares traded per day, and then consults a table to identify what range among the whole set of ranges for a factor represents that volume. The table, which may arrange the data entered into it in rows and columns, may contain some symbols representing a security or a market condition and associated values or ranges of values in coded form. This scheme, and the process for evaluating the factor tables, is used for all of the factors the system considers to explain securities. The number and types of factors is not specifically set and can be defined by the user or even changed dynamically. It is also possible to include blind factors (a factor that is defined only by the user), or factors that are calculated in some algorithmic way, such as a Principle Components Analysis (PCA) model.

The second component, an aggregator, includes a processor and a database and operates to adjust ranking numbers associated with each factor to represent the relative venue performance of a trade in a given security or investment instrument.

The third component, a scoring unit, scores a set of factors by combining the factor rankings associated with each factor in the set as it relates to each trading venue. The scored data is then returned in the form of a sorted venue/score set with higher performing trading venues appearing first in a list presented to the user trader.

The ATOM system of the present disclosure further includes an internal feature that improves the efficiency of the aggregator by scoring its own performance. The system looks at past success, i.e., by determining which recommendation produced by the ATOM system included factors which were most consistent with each other and produced the most predictable recommendation. Then, the factors used in the analysis may be weighted as necessary to refine or adjust the self-scoring information.

### DETAILED DESCRIPTION

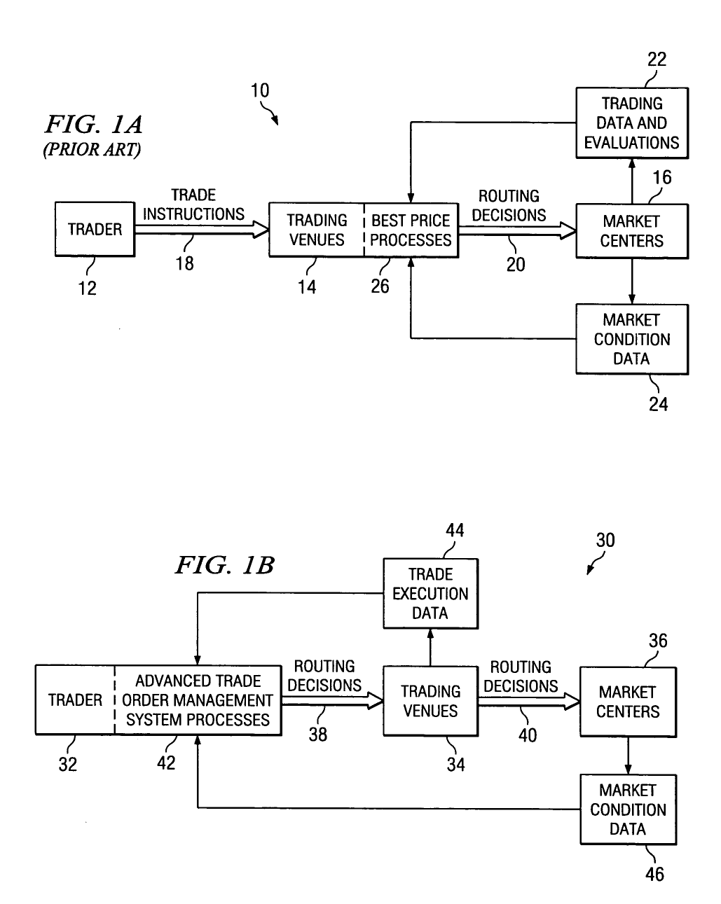

Referring to FIG. 1A, there is illustrated a block diagram of a prior art trading model 10 for trading investment securities such as stocks, bonds, and a wide variety of finds well known in the prior art. Three principal participants, a trader 12, trading venues 14, and market centers 16 are involved. Typically, a trader 12 issues trade instructions 18 to one or more trading venues 14, which in turn route the trade to market centers according to routing decisions 20. Information in the form of trading data and evaluations 22 of trading activity and performance, and market condition data 24 may be fed back to the trading venues 14 for use in making the routing decisions 20. The routing decisions 20 may be the outcome of best price processes 26, based on the feedback information 22, 24. The best price processes 26 maybe any number of algorithms or measuring methods well known to persons skilled in the art.

In contrast, FIG. 1B illustrates a block diagram of one embodiment of a trading model 30 of the invention according to the present disclosure. This trading model 30 solves the routing problem of the trader 32 in selecting the most efficient of the plurality of trading venues 34 that are available for accessing the market centers 36 to trade an investment security. In this model, routing decisions 38 to select one or more trading venues 34 for executing a particular trade are made by the trader 32. Further, routing decisions 40 to select one or more market centers 36 are made by the trading venues 34. The routing decisions 38 made by the trader 32 are facilitated by an Advanced Trade Order Management (ATOM) system 42, also known as ATOM processes 42 or simply ATOM system 42, operated by the trader 32. The ATOM processes 42 utilize trade execution data 44, describing the trading performance of the trading venues 34, which is fed back from the trading venues 34 to the ATOM processes 42. The ATOM system 42 also utilizes market condition data 46 fed back from the market centers 36.

As will be described herein below, the ATOM system 42 largely automates the trader's (32) task of making the routing decisions 38 by evaluating the available information in light of the trader's (32) investment trading instructions and presents a ranked listing of trading venues 34 to the trader 32. The ranked listing measures the efficiency of the trading venues 34 as expressed in the slippage in the price of the security from the time the order is entered until the time the trade order is executed. The effect of the ATOM process 42 is to minimize the amount of the slippage by enabling the rapid selection by the trader 32 of the trading venue 34 that has outperformed other trading venues—i.e., best minimized the slippage in trades for the same investment security or for an investment security having similar characteristics.

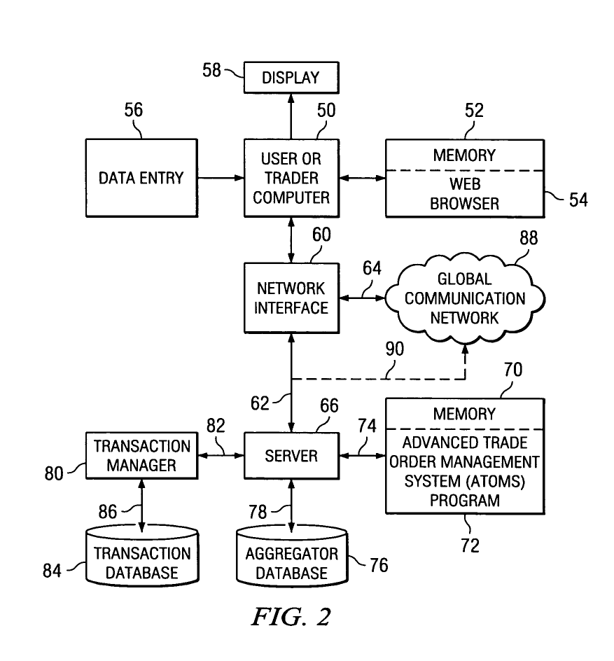

Referring to FIG. 2, there is illustrated a system block diagram of one embodiment of the invention of the present disclosure. A user, i.e., trader, location may include a user computer 50, a memory 52, which may include a web browser 54, a data entry unit 56, a display 58 and a network interface 60. The network interface 60 is coupled between the user or trader computer 50 via a link 62 to a server 66. The server 66 is shown coupled to a memory 70 having resident therein an Advanced Trade Order Management (ATOM) system program 72 via a bidirectional link 74. The server is also shown coupled to an aggregator database 76 via a link 78 and to a transaction manager 80 via a link 82. The transaction manager 80 is shown coupled to a transaction database 84 via a link 86. It will be appreciated that all of the links between units of the system are typically bidirectional except between the data entry unit 56 and the trader computer 50.

Continuing with FIG. 2, in an alternate embodiment of the present invention, a global communication network (GCN) 88 may be coupled to the trader computer 50 at a user location 32 (see FIG. 1B) via the network interface 60 and an individual bidirectional link 64 shown as a phantom line to indicate that it is an alternate embodiment. The GCN may be the well-known Internet or it may be any other electronic communications network suitable for the purpose, including a local network serving the needs of the trader 32. The server 66 may also be coupled to the GCN 88 via a bidirectional link 90, also shown in a phantom line to indicate this as an alternate embodiment. Of course, this alternate embodiment would be facilitated by including the web browser 54 in the user computer system 50.

In another alternate embodiment of the present invention, the memory 70, including the ATOM program 72, the aggregator database 76, and the transaction manager 80 and database 84, may be directly coupled with or incorporated into the user or trader computer 50, with the user or trader computer 50 taking the place and performing the functionality of the server 66. Accordingly the bidirectional links 62, 74, 78, 82, and 86 would be modified as necessary. The network interface 60 would then not be required unless some aspect of the system would need to interact with the GCN 88.

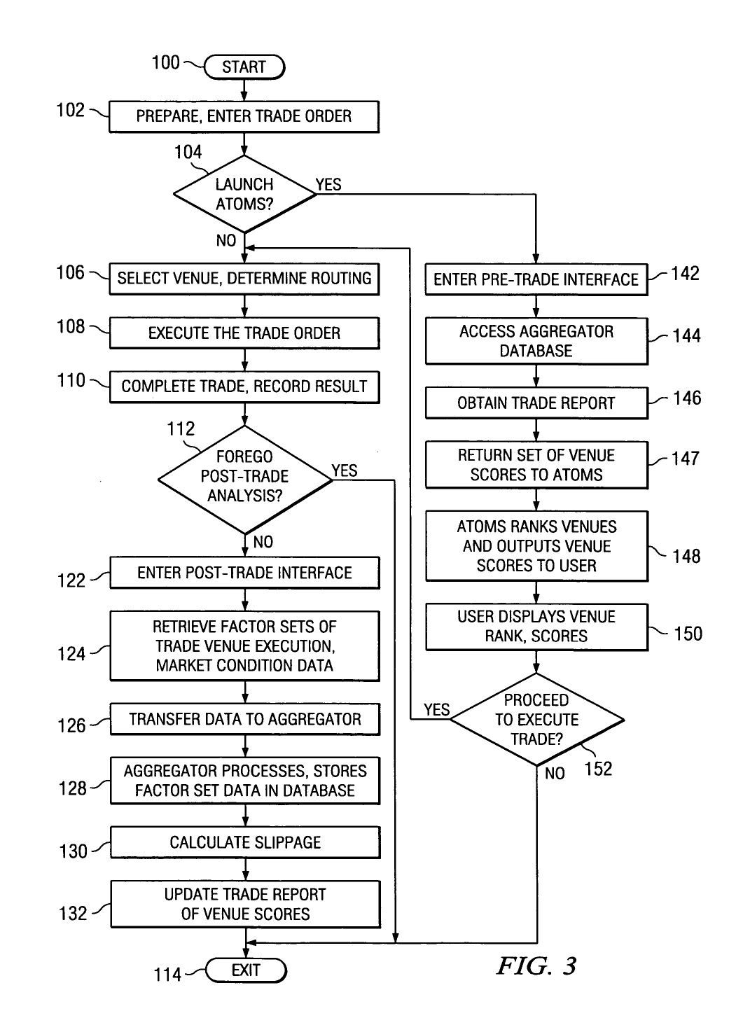

Referring to FIG. 3, there is illustrated a flow diagram for a method of the embodiment of the present disclosure illustrated in FIG. 2, primarily from a system perspective. The process begins at a start block 100, and proceeds to step 102 to prepare and enter a trade order to buy or sell a stock, bond or commodity share and the like. In the next step 104 a decision is made whether to launch the Advanced Trade Order Management ATOM system 22 shown in FIG. 1. If NO, the flow proceeds to step 106 wherein the routing of the trade is determined. Following determining the routing, the trade order is executed in step 108, followed by completing the trade in step 110, which includes recording the result, in such terms as the number of shares, the price, the settlement date, and any other information about the trade or the venue which handled the trade. Upon completing the trade, the process flows to a decision step 112 to determine whether to forego post trade analysis. If the decision is YES, the process exits at step 114.

It will be appreciated by those skilled in the art that the process just described in steps 100 through 114, with decision step 104 determined in the negative and step 112 in the affirmative, is essentially a conventional trading process, which may or may not include electronic processing steps to facilitate the transaction. As will be apparent in the following description, the ATOM system 22 of the present invention has been integrated into the conventional trade order system in a way that minimizes the cost to the user yet enables improved functionality in terms of evaluating and selecting trading venues. This improved functionality in turn results in improved trading efficiency and reduced trading costs.

Continuing with FIG. 3, and returning to decision step 112, if the decision to forego post-trade analysis was NO, the system proceeds to enter a post-trade interface in step 122. A post-trade interface is entered after a trade has been executed, to gather information about the trade for tracking, analysis, or measurement purposes. Thereafter, the flow advances to step 124 to retrieve trading venue execution data and market condition data from the post-trade interface and process them into a factor correlation matrix, a set of tables of factor and routing information to be used in evaluating the data. This information is then transferred to an aggregator database (76 in FIG. 2) in step 126, for storage in the aggregator database 76. In step 128, the aggregator database 76 further processes the information about the trading venue and the trade, compiles a trade report in step 130 according to a predetermined format and stores it in the form of factor sets in the aggregator database 26. Thereafter, the flow proceeds to step 130 to calculate the slippage in the price during the trading process, followed by updating the trade report of venue scores in step 132 with the slippage information and exiting the routine in step 114 to await the next trade order.

Returning to step 104, if and when the decision in step 104 is YES, the process advances to step 142, to enter the pre-trade interface. A pre-trade interface is entered to retrieve and analyze reports or other information about venue trading activity and the condition of the market centers preparatory to making a decision to trade an investment security. The process entered at the pre-trade interface may also include ranking the available trading venues in order of their performance as measured by one or more variables considered by the ATOM system. It will be understood that the post-trade nor the pre-trade interfaces are software modules that form part of the ATOM system 72 executed by the server 66 of FIG. 2. The ATOM system 72 next retrieves the factor set data in step 144, which is followed by step 146 to access the aggregator database 76 to obtain the trade report stored in the aggregator database 76. Upon analyzing the trade report, the aggregator database 76 returns a set of venue scores to the ATOM system 72, which, in step 148, ranks and outputs venue scores to the user computer 50 that originally accessed the ATOM system 72. These venue scores are then displayed on the user display 58 in step 150, where they may be interpreted and utilized by the trader at the user computer 50. Thereafter, the process flows to a decision step 152 to choose to re-enter step 106 to determine or select the routing for a trade (if YES) or to exit at step 114 (if NO).

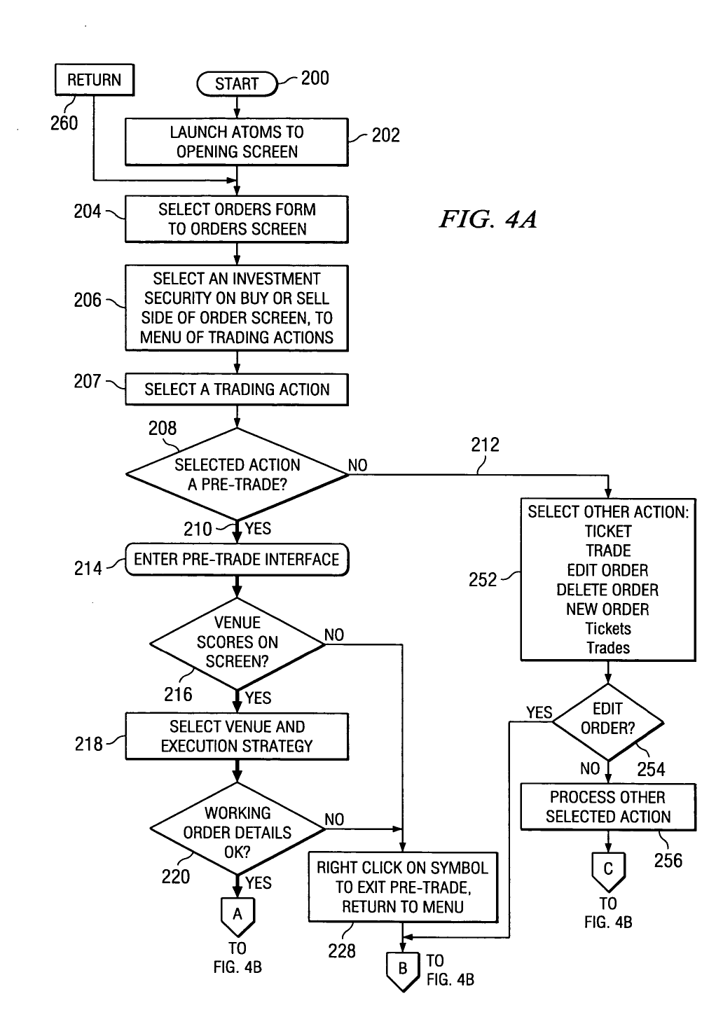

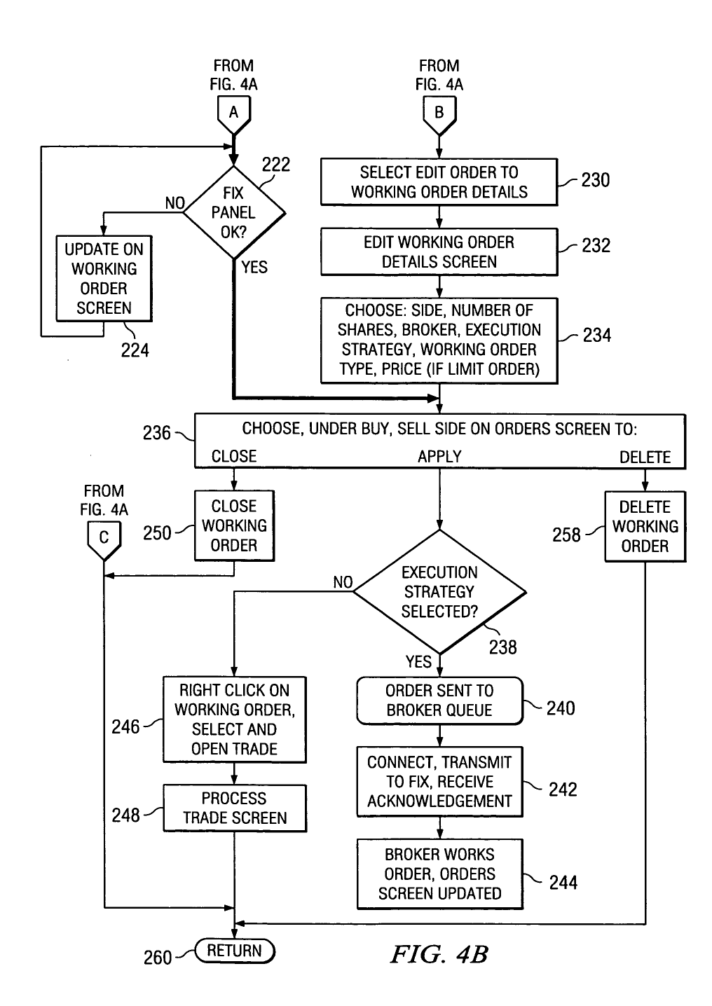

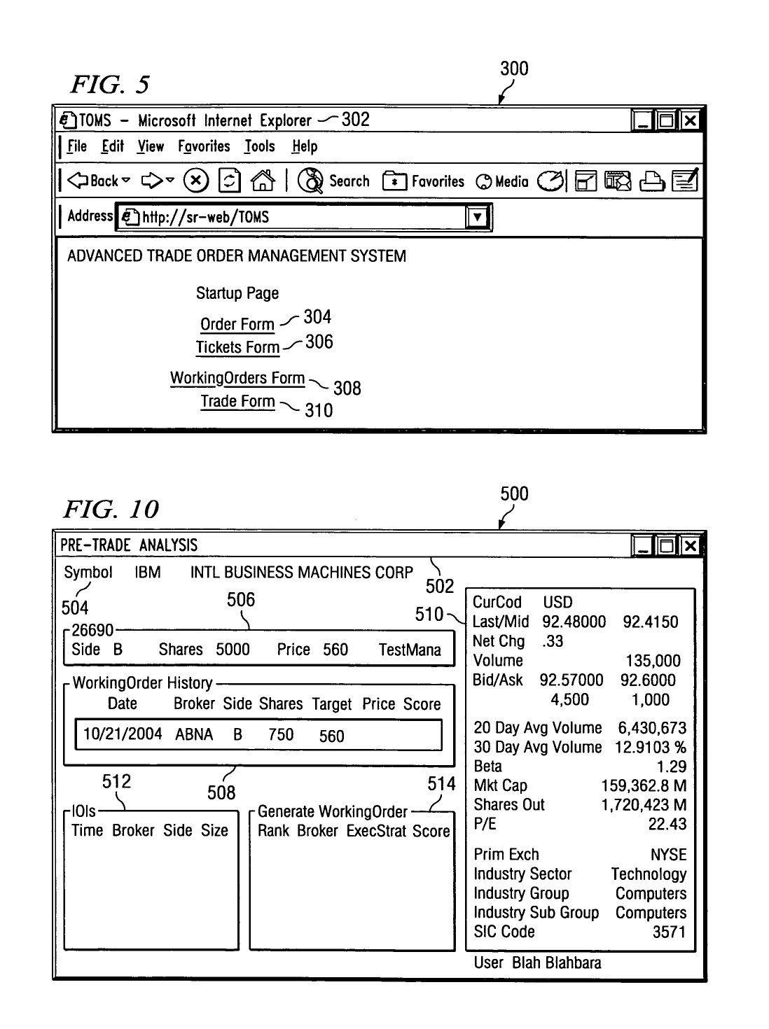

Referring to FIGS. 4A and 4B, there are illustrated first and second portions of a flow diagram, primarily from a user's perspective, for a method of one embodiment of the present disclosure. The flow chart of FIGS. 4A and 4B can best be understood with the aid of the following FIGS. 5 through 11, which will be referred-to from time to time. Further, it should be noted that for certain portions of the flow chart illustrated in FIGS. 4A and 4B, the process path is shown as a heavy line. This heavy line indicates that the flow is proceeding along a Pre-Trade Analysis path, which provides the highly efficient trading venue scoring and routing capability of the ATOM system. Along this double line path, several steps are denoted with an asterisk, indicating that it is a step requiring user/trader intervention, usually to select a trading venue or a trading action.

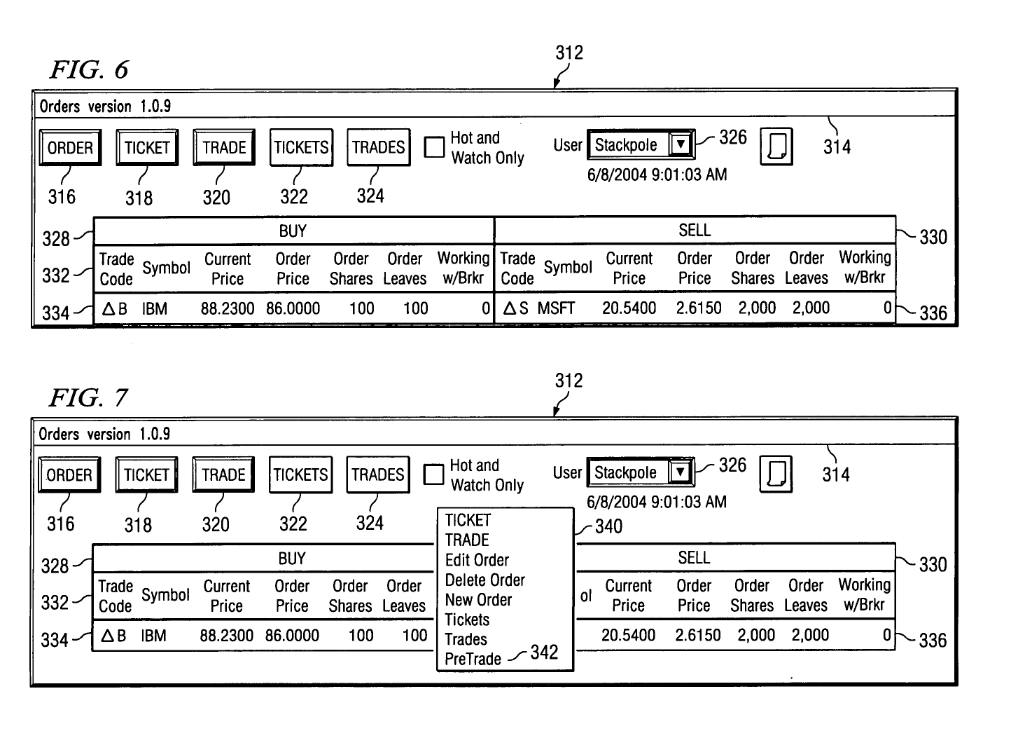

The process begins in FIG. 4A at a start block 200, proceeding to step 202 to launch the ATOMS opening screen (See FIG. 5) on the display 58 (See FIG. 2). In step 204, the user selects (i.e., clicks on) the Orders form on the opening screen to go to the Orders screen (See FIG. 6). On the Orders screen, the user or trader, in step 206 selects an investment security (i.e., clicks a mouse cursor on the symbol for the security such as IBM, MSFT, etc.) listed on either the Buy side (left side) or the Sell side (right side) of the screen. This action causes the system to display a menu of trading actions superimposed on the Orders screen (See FIG. 7). Next, the trader selects a trading action from the menu list in step 207, and the flow advances to a decision step 208 asking whether the selected action is a Pre-Trade action. If YES is the response, the process continues along a heavy line path to step 216, i.e., it enters the Pre-Trade interface (a software module). If trading venue scores are displayed on the screen, a YES response to step 216 leads along the heavy line path to step 218 to select a trading venue and trading strategy from the displayed trading venue list. If NO is the response to step 216, the user is led to step 228 to be described later herein below.

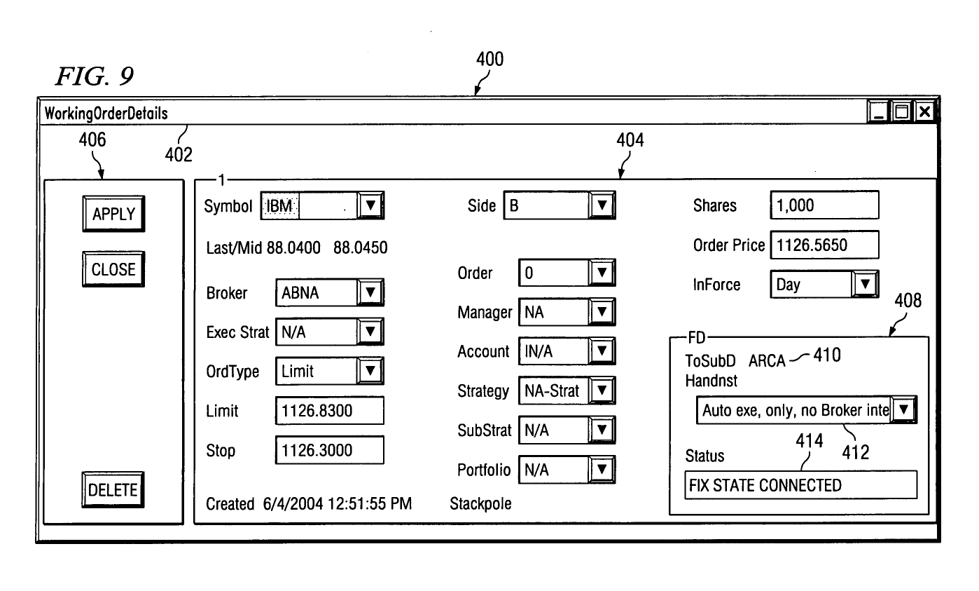

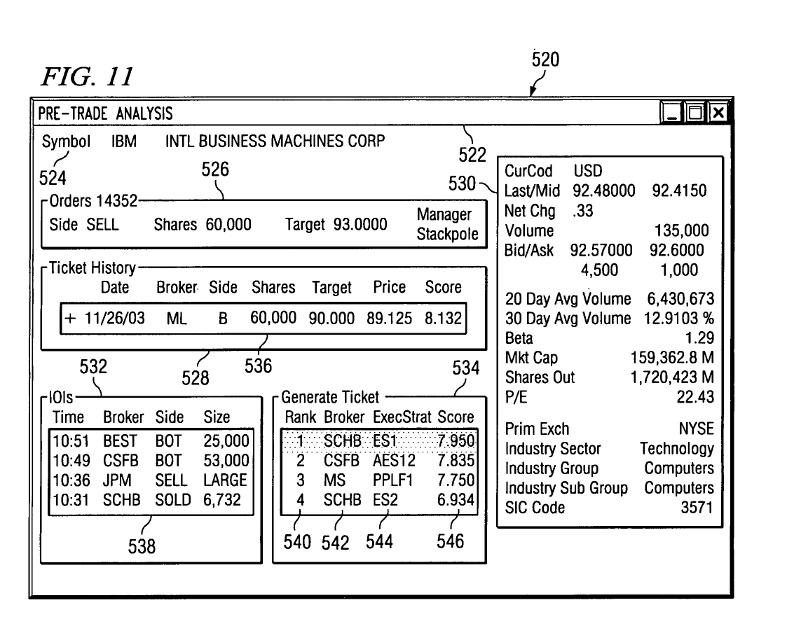

After selecting a trading venue and execution strategy in step 218, by clicking an entry in the listing in a Generate Ticket panel of a Pre-Trade Analysis screen (See FIG. 11), a decision step 220 along the heavy line path is reached to determine whether the working order details displayed on the screen are OK. If NO, the user/trader is led to step 228 to be described herein below. If YES, the user/trader is led along the heavy line path to another decision step 222 in FIG. 4B, which asks whether the FIX (Financial Information exchange) panel information in the Working Order Details screen (See FIG. 9) is OK. The Financial Information eXchange is a communication network of financial institutions that operates for the exchange of information about and the automated trading of financial instruments. If the FIX panel information is NOT OK, the flow proceeds along a path to a step 224 to update the Working Order screen before returning to the heavy line input along path “A” to the step 222.

Continuing with FIG. 4B, if the FIX panel information is OK, indicated by a YES response to the query posed in step 222, the flow proceeds along a heavy line path to a step 236 to enter a command to the system selected by the user/trader to further process the trade order according to one of three actions. Selecting the APPLY action in step 236 causes a connection to the selected trading venue or the FIX network for the venue, e.g., a broker, to execute the order if an execution strategy was selected in step 238. If an execution strategy was not selected in step 238, the routine continues to step 246, where a right click on the working order of interest causes selection and opening of the TRADE trading action, followed by processing of the Trade screen in step 248. After the trade is processed in this flow path, the system returns via step 260 to the opening screen going into step 204 of FIG. 4A. Back in step 238, selecting the DELETE action causes deletion of the working order in step 258 and return (step 260) to the opening screen after step 202. Selecting the CLOSE action causes the flow to advance to step 250 to close the working order and return via step 260.

Returning to the decision step 216 in FIG. 4A, to determine whether venues scores are present on the screen, if the response is negative, the process advances to step 228 to complete the routing of the trade manually. After a right click on the symbol for the investment security to exit the Pre-Trade Analysis screen, the flow returns to the trading action menu selected in step 207 so the user/trader can select “Edit Order,” call up the Working Order Details screen in step 230 on FIG. 4B and edit the working order details in the following step 232. Step 234 summarizes the kind of parameters that may be edited on the Working Order Detail screen, including choosing the side, the number of shares, the broker or venue, the execution strategy, the type of working order (stop, limit, etc.), the price (if applicable), etc. When the Working Order Details screen is filled in, the routine may proceed to the execution steps 236 and 238, described in the preceding paragraph.

Returning to the decision step 208 in FIG. 4A, when the response is that the selected action is not a Pre-Trade action, the trader typically has not elected to take advantage of the substantially automated venue routing process provided by the ATOM system. The flow therefore advances along a single line path 212 to a step 252 to review the other trade action alternatives listed in the box for step 252. These alternative trade actions, to be described in the following paragraph, will require substantial trader intervention and include, in the order listed on the trading action menu (See FIG. 7, Reference Number 340), TICKET, TRADE, Edit Order, Delete Order, New Order, Tickets, and Trades. From step 252, the process continues to step 254, a decision step that asks whether the trader wishes to edit the order? If YES, the flow advances to step 230 in FIG. 4B, entering the path “B” to edit the Working Order Details. If NO, the flow advances to step 256 in FIG. 4A to process the trading action selected in step 252. Thereafter, the flow follows the path “C” to the return path at step 260 in FIG. 4B.

The alternative trading actions provide various ways to process a trade order using the ATOM system. These actions are primarily involved with features of the ATOM system other than the Pre-Trade Analysis and Post-Trade Analysis aspects of the ATOM system and thus will be only briefly described herein. The TICKET command opens a Quick Ticket screen for rapid entry of a reduced set of trading data. The TRADE command opens a Trade Details screen which automatically inserts details of a trade that has already occurred, to inform the ATOM system and the trader of the details of the trade. The Edit Order command has been described herein above (See steps 230 to 234, for example). Similarly, the Delete Order command has been described at step 236. A New Order command opens an order form on the screen for the user/trader to enter the details of an order to trade a security. The Tickets command opens a Tickets screen enabling the user/trader to view current information about the tickets that have been input through a Tickets screen and to link to other commands. Similarly, the Trades command opens a Trades screen enabling the user/trader to view current information about trades that have been input through the Trade screen and to ink to other commands.

FIGS. 5 through 11 illustrate several graphic displays used in the ATOM system that are involved in the venue scoring and selection features of the illustrated embodiment of the present invention. In a number of the display screens, trading data is shown to illustrate to functioning of the system. It should be appreciated that all of this data is fictitious, even though symbols identifying several well-known business entities are shown purely for illustration purposes.

Referring to FIG. 5, there is illustrated an opening screen display for an opening step of the method of FIG. 4. The opening screen 300, also called a start up page, includes a title bar 302 with a TOMS (for Trade Order Management System) identifier therein. In the illustration shown in FIG. 5, an Internet identifier may be shown in the title bar 302 or, if the TOMS resides solely on the user/trader computer, a corresponding identifier may appear in the title bar 302 instead. At an insertion point of the window or screen of the start up page, there may be shown a title “Advanced Trade Order Management System,” followed by the following legends: Orders Form 304, Tickets Form 306, WorkingOrders Form 308, and Trades Form 310. These legends provide direct links to the respective forms.

Referring to FIG. 6, there is illustrated a screen display for a trade ordering step of the method of FIG. 4. An Orders screen 312 is shown, identified by the name Orders version 1.0.9 in the title bar 314. A masthead just below the title bar 314 includes buttons for accessing various functions such as ORDER 316, TICKET 318, TRADE 320, Tickets 322, and Trades 324, as well as a user list box 326. Below the masthead is a subtitle bar having a Buy side 328 and a Sell side 330, which divide the screen into left and right halves corresponding to Buy and Sell types of orders respectively. The Buy and Sell portions of the screen are divided into rows and columns. The columns are designated with parameter names in a second subtitle bar 332 such as, reading from left to right, Trade Code, Symbol, Current Price, Order Price, Order shares, and Order Leaves on both the Buy and the Sell sides. In addition the Buy side may have an additional column for Working w/Broker, the number of shares of an order not yet executed, and the like. Each row of the screen contains a description of a security, on both the Buy and Sell sides, identified in the Symbol column with the NYSE symbol if the entity is a member of the NYSE, etc. For example, on the Buy side, an entry for IBM (International Business Machines Corporation) stock 334 appears. Similarly, on the Sell side, an entry for MSFT (Microsoft Corporation) stock 336 appears.

Referring to FIG. 7, there is illustrated a screen display for selecting a trade action step of the method of FIG. 4. The screen image shown is the same as the image shown in FIG. 6, and bears the same reference numbers, with the addition of a drop down menu 340 having a list of trading actions thereon, including a Pre-Trade action 342 at the bottom of the list.

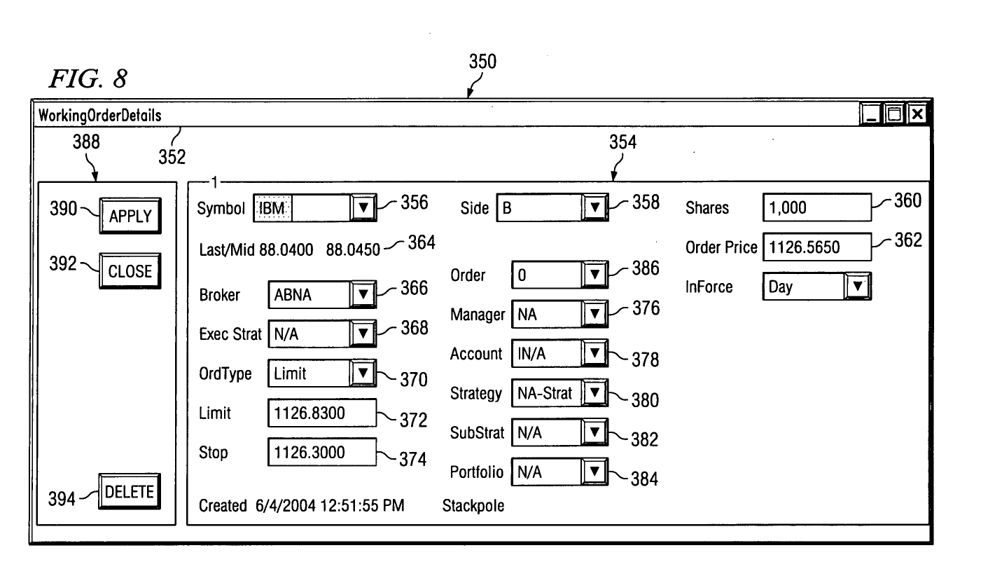

Referring to FIG. 8, there is illustrated a screen display for a step of entering a trade order of the method of FIG. 4. The screen 350, called a WorkingOrder Details screen in the title bar 352, includes a number of selector buttons and text boxes for giving a command or entering information into the screen for operation by the ATOM system. Included in a field 354 of the screen 350 are the following text boxes: Symbol 356, Side 358, Shares 360, Order Price 362, Broker 366, Exec Strat (for execution strategy) 368, Ord Type (for order type) 370, Limit 372, Stop 374, Manager 376, Account 378, Strategy 380, SubStrat (for sub-strategy) 382, and portfolio 384. Also included in the field 354 of the screen 350 is a line entry for Last/Mid prices. Along the left hand side 388 of the screen 350 are buttons for APPLY 390, CLOSE 392, and DELETE 394. Clicking a louse cursor on these “buttons” causes the associated operation, as described previously in step 236 of FIG. 4B.

Referring to FIG. 9, there is illustrated a screen display for a step of checking a trade order of the method of FIG. 4. The screen 400, called a WorkingOrder Details screen in the title bar 402, is very similar to the WorkingOrder Details screen 350 except for the addition of a FIX panel 408 in the lower right hand corner of the screen 400. The screen 400 also includes the APPLY, CLOSE, and DELETE selector buttons for giving a command in the left hand panel 406, and the same text boxes 356 to 384 in a panel 404 for entering information into the screen for operation by the ATOM system. The FIX panel 408 includes a TgtSubID text line 410, a HandlInst text box 412, and a Status box 414. The FIX panel 408 provides for entering information about the connection to the Financial Information eXchange for communicating with trading venues and other financial institutions and resources. The important portion of the FIX panel 408 for the purpose of the present disclosure is the text box 414 at the bottom of the FIX panel 408. If the text box is green (in the illustrative embodiment) and includes the legend FIX STATE CONNECTED, a connection has been established and an electronic (order) ticket will be sent to the broker and execution strategy chosen for the order. If, however, the text box 414 is a salmon or pink color (in the illustrative embodiment), a connection has not been established—likely because the broker (i.e., venue) chosen is not accessible through the FIX network—and the trader should seek to find another FIX connection to the chosen broker (venue).

Referring to FIG. 10, there is illustrated a screen display for a pre-trade analysis step of the method of FIG. 4. A Pre-Trade Analysis screen 500 is shown, including a title bar 502 and a Symbol line 504 with the symbol and full name for the entity IBM entered therein. Also shown are several panels in the screen including order parameters 506, WorkingOrder History 508, market condition factors 510, trade execution data panel 512, which is blank in FIG. 10, and a Generate WorkingOrder panel 514, which is also blank in FIG. 10 but is provided to display venue score and trade execution strategy data. The order parameters include a designation for Buy side, an order of 5000 shares OF IBM at a price of $560. It will be noted that all data values shown in this screen are fictitious. In the WorkingOrder History panel 508, having column headings for Date (of trade), Broker (identity), Side, Shares, Target Price, and Score, typical entries are provided to illustrate the function of this panel as a reference for the trader to use in making trading decisions.

Referring to FIG. 11, there is illustrated a screen display for a step of receiving a result of a pre-trade analysis step of the method of FIG. 4. The Pre-Trade Analysis screen 520 is shown, including the title bar 522 and a Symbol line 524 with the symbol and full name for the entity IBM entered therein. Also shown are several panels in the screen including order parameters 526, a Ticket History 528, and market condition factors 530. The Ticket History panel 528 includes column headings for the trade Date, Broker, Side, number of Shares, the Target price, the trade Price, and a Score. The data for an illustrative trade entry 536 performed by the Broker ML for a Buy side order for 60,000 shares at a target price of $90.00, a trade price of $89.125 and a Score of 8.132 are shown. The Pre-Trade Analysis screen 520 has essentially all of the same features as FIG. 10 except that much of the data is different and the trade execution data panel 532 and the Generate Ticket panel 534 are filled in to show that the pre-trade analysis has taken place. Thus, at the time of the display in FIG. 11, the system indicates by the shaded text line in the first line of the Generate Ticket panel 534 that the number one ranking broker (SCHB) and Execution Strategy (ExecStrat: ES1) at the time of the display has been selected by the trader. Other entries in the Generate Ticket panel 534, ranked 2, 3, and 4 after the first entry include the venues CSFB, MS, and SCHB, with their respective execution strategies AES12, PPLF1, and ES2. It is apparent that one broker, SCHB, offered two execution strategies, ES1 and ES2. In general, the execution strategies may be particular processes or algorithms employed by the venue to execute a particular trade. For example, a strategy may be “aggressive” or “passive.” Or, the strategy may be characterized according to a particular algorithm offered by the venue.

### SUMMARY

An Advanced Trade Order Management (ATOM) method and system has been described for enabling traders to obtain a verifiably independent measure, of how individual trading venues perform in a given trade. The system allows investment managers for hedge funds and other investment advisors with less than $500 million under management to service their investment accounts more effectively by normalizing and automating transaction and allocation data. It requires no information technology investment beyond the ATOM system program, a computer and a network interface. Furthermore, the ATOM system software offers access to all major trading venues and tracks slippage for each trade. This allows the system to make intelligent trade routing recommendations based on previous trading history. The core system is trading venue agnostic; that is, the core system itself operates without knowledge of the trading venues that perform the trading. However, the front end—the interface of the system—can be custom crafted for each Broker Dealer. The ATOM system is also self-scoring, that enables improvements to the efficiency of the subscribing investment manager.

While the invention has been shown in only one of its forms, it is not thus limited but is susceptible to various changes and modifications without departing from the spirit thereof.

1. A method for selecting a trading venue, comprising the steps of:
launching a program from a memory coupled to a user computer having a display to access an advanced trade order management (ATOM) system;
performing a post trade data analysis for a specified investment from trading venue execution data and market condition data into a trade report for the specified investment;
performing a pre-trade analysis of the trade report for the specified investment for a plurality of trading venues to provide a scored venue display; and
selecting a venue from the scored venue display.

2. The method of claim 1, wherein the step of launching comprises the steps of:
entering a command to launch the program and display an opening screen;
selecting an Orders Form and display an Orders screen;
selecting an investment security on either a Buy side or a Sell side of the Orders screen and display a menu of trading actions; and
selecting a trading action from the menu.

3. The method of claim 1, wherein the step of performing a post trade analysis comprises the steps of:
entering a post-trade interface for retrieving and compiling the trading venue execution data for one or more trading venues and the market condition data as factor sets;
transferring the factor sets to an aggregator for storage and processing;
producing correlation matrices from the factor sets to be stored in an aggregator database; and
preparing trade reports having venue scores based on the correlation matrices for the one or more trading venues.

4. The method of claim 1, wherein the step of performing a pre-trade analysis comprises the steps of:
entering a pre-trade interface for retrieving a trade report for the specified investment;
accessing the aggregator database to return a set of venue scores from processing the trade report stored in the database; and
displaying a list of trading venues, ranked in order of venue scores.

5. The method of claim 1, wherein the step of selecting a venue comprises the step of:
selecting the venue score associated with a desired trading strategy if multiple trading strategies are shown for a single venue; or
selecting the highest venue score if two or more trading venues are listed without associated trading strategies

6. A system for selecting a trading venue, comprising:
a computer system coupled to a memory having a program for an advanced trade order management (ATOM) system stored therein, the program operable to perform pre-trade analysis based on post trade data for a specified investment to produce a trade report on one or more trading venues;
an aggregator database coupled to the computer and accessed by the program for processing a plurality of factors derived from the post trade data and storing correlation tables relating value ranges of each of the factors to a plurality of venues to be accessed to produce the trade report on the one or more trading venues; and
a display coupled to the computer system for displaying a scored list of trading venues provided by pre-trade analysis of the trade reports.

7. The system of claim 6, wherein the computer system comprises:
a network interface to a communication network; and
a broker server coupled to the communication network.

8. The system of claim 7, wherein the broker server further comprises a second memory coupled thereto having resident therein the aggregator database.

9. The system of claim 6, wherein the program comprises:
an opening screen on the display for selecting an Orders screen listing one or more investment selections; and
a menu of trading actions presented upon selecting an investment from the Orders screen, wherein a trading action maybe selected from the group consisting of TICKET, TRADE, edit order, delete order, new order, tickets, trades, and pretrade.

10. The system of claim 9, wherein selecting the pretrade trading action generates a ranked list of the plurality of trading venues from scores obtained by processing the trade report, enabling a selection of an optimum trading venue to perform a desired investment trade.

11. The system of claim 6, wherein the post trade data includes trade execution data for the plurality of trading venues and market condition data for a market accessible via at least one of the trading venues.

12. A method for scoring performance of a trading venue in trading an investment instrument at a market, comprising the steps of:
launching a program providing an advanced trade order management (ATOM) system on a computer at a trader location, the computer including a memory and a display and coupled to a plurality of trading venues interacting with the market;
encoding trading venue execution and market condition data for the investment instrument into a plurality of trading factors expressed in a plurality of ranges in data values;
assigning each range of data values of a trading factor to a row of a table and each of the plurality of trading venues to a column of the table, the table mapped respectively to the rows and columns of a memory array; and
associating a score calculated to represent the performance of each trading venue on the respective factor range value for the investment instrument with an address location in the table defined by row and column coordinates of the memory array.

13. The method of claim 12, wherein the step of launching comprises the steps of:
entering a command to launch the program and display an Orders screen; and
selecting an investment instrument and a trading action on either a Buy side or a Sell side of the Orders screen.

14. The method of claim 13, wherein the step of selecting a trading action comprises selecting a trading action from the group consisting of TICKET, TRADE, edit order, delete order, new order, tickets, trades, and pre-trade.

15. The method of claim 14, wherein the step of selecting a trading action comprises selecting the pre-trade action.

16. The method of claim 12, wherein the step of encoding comprises encoding the data for the trading factors with integer numbers.

17. The method of claim 12, wherein the step of encoding comprises the step of defining any trading factor that may be expressed in terms of the trading venue execution data and the market condition data that is available from the trading venue and the market.

18. The method of claim 12, wherein the step of encoding comprises the step of selecting one or more of the plurality of trading factors from the group consisting of previous day volume, previous day highest price, previous day lowest price, five day moving average closing price, five day moving average daily volume, five day highest price, five day lowest price, five day price volatility, five day volume volatility and primary exchange beta.

19. The method of claim 12, wherein the step of encoding comprises the step of selecting one or more of the plurality of trading factors from the group consisting of twenty day moving average closing price, twenty day moving average daily volume, twenty day highest price, twenty day lowest price, twenty day price volatility, twenty day volume volatility and primary exchange beta.

20. The method of claim 12, wherein the assigning step comprises the step of defining at each intersection of a row assignment and a column assignment represents an address location for a performance score.

21. The method of claim 12, wherein the step of associating further comprises the step of updating the contents of the table at each address location each time a trade is made.

22. The method of claim 21, wherein the step of associating further comprises the step of assembling a ranked listing of the updated scores for a plurality of trading venues onto the display.

23. The method of claim 12, wherein the step of associating further comprises the step of updating the contents of the table at each address location for each trade either upward if the trade is satisfactory or downward if the trade is not satisfactory.

24. A method for selecting a trading venue in a trade order management system, comprising the steps of:
launching a program on a user computer having a memory and a display to access an advanced trade order management (ATOM) system at a broker server coupled to the user computer;
performing a post trade analysis of trading venue execution data and market condition data, comprising the steps of:
(a) inputting post-trade analysis results into ATOM for a specified investment from a market feed to a post trade interface;
(b) processing factor sets retrieved from the post trade interface into a factor correlation matrix for storage in an aggregator database;
(c) updating a trade report in the aggregator database from the factor correlation matrices for a plurality of trading venues dealing in the specified investment; and
performing a pre-trade analysis of trading venue performance reports, comprising the steps of:
(a) adjusting ranking numbers associated with each factor to reflect venue performance on a trade of the plurality of trading venues;
(b) scoring a set of factors by combining factor rankings associated with each of the plurality of trading venues for display as a sorted venue score set, in order of highest performing venues; and
selecting a venue from the sorted venue score set on the display.
